(19) United States
(12) Patent Application Publication
(10) Pub. No.: US 2016/0032132 A1
(43) Pub. Date: Feb. 4, 2016

(54) METHOD AND COMPOSITION FOR DEPOSITING TEXTURED IMPRINTS ONTO A SUBSTRATE SURFACE

(71) Applicant: CHURCH & DWIGHT CO., INC., Princeton, NJ (US)

(72) Inventors: Michael J. Harrison, Princeton, NJ (US); Jason R. Kieke, Freehold, NJ (US); Benny S. Yam, Holmdel, NJ (US); Andrew Y. Oleson, Lambertville, NJ (US); William D. Platt, Lumberton, NJ (US); Richard Grotyohann, Hillsborough, NJ (US); Richard Wilhelm Janse van Rensburg, Cambridge (GB); Luis Muniz, Brooklyn, NY (US)

(21) Appl. No.: 14/774,916

(22) PCT Filed: Mar. 13, 2014
(86) PCT No.: PCT/US14/26450

§ 371 Date: Sep. 11, 2015

Related U.S. Application Data
(60) Provisional application No. 61/791,640, filed on Mar. 15, 2013.

(51) Int. Cl. C09D 133/00; B41F 3/00

(52) U.S. Cl. CPC C09D 133/00; B41F 3/00

(57) ABSTRACT

A composition for depositing textured imprints onto an elastomeric substrate includes an aqueous film-forming polymeric emulsion suspended in an aqueous medium. In particular, the composition is formulated for deposition onto a substrate to impart visual or tactile texture to the substrate upon deposition. The present invention is further directed to methods for depositing the same as textured imprints onto the elastomeric substrate, and articles formed therefrom.

### CROSS-REFERENCE TO RELATED APPLICATION

This application is related to U.S. Provisional Patent Application Ser. No. 61/791,640 filed Mar. 15, 2013 and takes priority therefrom.

### FIELD OF THE INVENTION

The present invention relates to deposition methods and compositions, and more particularly, methods and compositions for depositing textured imprints onto a substrate.

### BACKGROUND OF THE INVENTION

Printing is a process of depositing a substance onto the surface of a receiving substrate to produce graphic images (e.g., text and designs). A typical example of printing involves depositing ink on paper using a printing press. The development of print technologies has provided major progress in many areas on a large scale basis including the dissemination of information and the manufacture of goods relying on such technologies. Two print methods commonly used for depositing or printing graphic images onto the receiving substrate are lithographic printing and screen printing.

Lithographic printing utilizes printing plates having patterns formed from a series of grooves into which a thick ink is initially deposited with a suitable applicator. The grooves are configured for retaining a quantity of ink, while the areas adjacent to the grooves are rendered free of ink through careful wiping and scraping. The corresponding pattern is transferred after impressing the ink-loaded grooves onto the substrate surface with sufficient pressure whereby the surface contacts the ink retained in the grooves. This method of printing is relatively inexpensive and the resolution, density and quality of the printed image is generally adequate. However, when used on soft, elastomeric materials, the printed images are less satisfactory.

Screen printing is a print method suitable for use on a wide range of materials including textiles, ceramics, wood, paper, glass, metal and plastic. The method involves the use of a woven mesh or screen supported on a frame. An ink-blocking stencil is formed by blocking off parts of the screen in the negative image of the print. The open, unblocked parts representing the positive image of the print permit passage of the ink onto the substrate surface. The ink is pressed through the open areas of the screen to deposit a sharp-edged image onto the substrate surface below. A fill blade or squeegee is generally used to force ink into the mesh openings by moving it across the stencil screen to promote transfer through capillary action. Screen printing is more versatile than traditional printing techniques. The surface does not have to be printed under pressure and it does not have to be planar or flat. Screen printing also provides good color depth, enhanced definition and overall better quality images.

High-throughput commercial printing utilizes solvent-based ink to ensure rapid drying and good adhesion to the substrate surface. However, such inks suffer several drawbacks. Certain substrates, such as those composed of an elastomeric material, are not compatible with such solvent-based inks. These inks are formulated with solvents that usually penetrate the elastomeric material causing temporary physical changes such as swelling. Although the elastomeric material eventually returns to its original state as the solvent evaporates, its physical properties including barrier integrity may be adversely affected. In addition to the problem of incompatibility with elastomeric materials, solvent-based inks contain components that pose potentially harmful health effects on humans through contact with such inks printed on such elastomeric materials.

Accordingly, there is a need for a method and composition for depositing textured imprints onto a substrate without adversely affecting or altering the underlying substrate and its physical properties. Furthermore, there is a need for a method and composition for depositing textured imprints onto a substrate to produce an article that is biocompatible, medically safe and at least substantially non-toxic for prolonged human contact and use.

### SUMMARY OF THE INVENTION

The present invention relates generally to a method and composition for depositing textured imprints onto a substrate. In particular, the composition of the present invention is formulated for deposition onto a substrate to impart visual or tactile texture to the substrate upon deposition. In this manner, the present invention can be applied to form decorative and/or functional elements on the surface of the substrate. The composition of the present invention is further formulated to provide an article that is biocompatible and medically safe for prolonged contact with human tissue including the skin and mucous membranes.

The composition includes a water-based, highly elastic fluid material exhibiting robust adherence and viscosity suitable for deposition on the surface of the substrate. The water-based, highly elastic fluid material is formulated to set or cure into a final solid form when adhered to the substrate surface. The present composition is especially compatible for use with elastomeric substrates and does not adversely alter or change the physical properties of the underlying elastomeric material.

The composition of the present invention can be used in a range of products including, but not limited to, prophylactic devices such as condoms; prosthetics; medical devices and instruments; sports/athletic gear or equipment; footwear; dental products; eyewear; and the like.

In one aspect of the present invention, there is provided a composition for depositing textured imprints onto a substrate, comprising an aqueous film-forming polymeric emulsion suspended in an aqueous medium.

In a second aspect of the present invention, there is provided a method for depositing textured imprints onto a substrate, comprising the step of depositing the above-mentioned composition onto a surface portion of the substrate.

In a third aspect of the present invention, there is provided an article comprising:

a substrate having a surface; and

the above-mentioned composition deposited on the substrate surface to form textured imprints adhering thereon.

In a fourth aspect of the present invention, there is provided an apparatus for depositing textured imprints onto a substrate, comprising:

a substrate holder adapted for securely retaining the substrate; and

deposition means operatively associated with the substrate holder for depositing the composition onto the surface of the substrate.

### BRIEF DESCRIPTION OF THE DRAWINGS

The following drawings are illustrative of embodiments of the present invention and are not intended to limit the invention as encompassed by the claims forming part of the application.

FIG. 1 is a perspective view of a system comprising a screen printer and a mandrel mounted carrier in one embodiment of the present invention;

FIG. 2 is a perspective view from below the system showing a deposition surface with two soft foam rubber ‘tracks’ (as indicated by the arrows) positioned under the screen on either side thereof in accordance with the present invention; and

FIG. 3 is a cross sectional view of an extruded plate printing apparatus configured for depositing textured imprints on the surface of a substrate in accordance with another embodiment of the present invention.

### DETAILED DESCRIPTION OF THE INVENTION

The present invention is directed to a method and composition for depositing textured imprints onto a substrate and to the textured imprinted substrates formed thereby. In particular, the composition of the present invention is formulated for deposition as a printable material or ink onto a substrate to form graphic images and/or impart visual or tactile texture to the substrate upon deposition. In this manner, the present invention can be applied to form textured decorative and/or functional elements on the surface of the substrate. The composition of the present invention is further formulated to provide an article that is biocompatible and medically safe for prolonged contact with human tissue including the skin and mucosal membranes.

The present composition is composed of a water-based, highly elastic fluid material exhibiting robust adherence and viscosity suitable for deposition on the surface of the substrate. The water-based, highly elastic fluid material is formulated to set or cure into a final solid state firmly adhering to the substrate surface. The present composition is especially compatible for use with elastomeric substrates and does not adversely alter or change the physical properties of the underlying elastomeric material. The present compositions are screen-printable, sufficiently elastic to accommodate extensions of up to 500%, adhere well enough to remain attached at these extensions, can be deposited at substantial thicknesses of up to and exceeding 100 microns, and are medically safe for human use.

The composition of the present invention can be used in a range of products including, but not limited to, prophylactic devices such as condoms; prosthetics; medical devices and instruments; sports/athletic gear or equipment; footwear; dental products; eyewear; and the like.

In one embodiment of the present invention, there is provided a composition for depositing textured imprints onto a substrate, including an aqueous film-forming polymeric emulsion suspended in an aqueous medium. The aqueous medium is preferably water. The polymeric emulsion may include natural polymers, synthetic polymers or a combination thereof. The aqueous film-forming polymeric emulsion may be in the form of a suspension of polymer microparticles. The present compositions are preferably in the form of high viscosity liquids formulated to support its weight for several minutes.

In a further embodiment of the present invention, the aqueous film forming polymeric emulsion is present in an amount of up to 80% by weight based on the total weight of the composition. In a preferred embodiment of the present invention the aqueous film forming polymeric emulsion is present in an amount of from about 50% to 70% by weight, more preferably from about 55% to 65% by weight, and most preferably from about 61% to 62% by weight.

In a preferred embodiment of the present invention, the aqueous film-forming polymeric emulsion is composed of a polymer selected, for example, from latex polymers, acrylic polymers, polyisoprene polymers, polyurethane polymers, polyvinyl polymers, polyepoxide polymers, polyvinyl chloride polymers, styernic block polymers and combinations thereof.

In one embodiment of the present invention, the aqueous film-forming polymeric emulsion is composed of an acrylic polymer. The amount of the acrylic polymer is generally in the range of from about 10% to 60% by weight based on the total weight of the emulsion, more preferably from about 20% to 50% by weight, and most preferably form about 30% to 40% by weight.

In another preferred embodiment of the present invention, the aqueous film-forming polymeric emulsion includes a mixture of latex polymer and acrylic polymer. The mixture of latex polymer and acrylic polymer has been determined to provide an optimal level of adhesion and printability on elastomeric substrates without adversely affecting the physical properties of the underlying substrate. This is especially desirable on elastomeric substrates such as condoms. The amounts of latex polymer and acrylic polymer are from about 10% to 90% by weight latex polymer and from about 10% to 90% by weight acrylic polymer based on the total weight of the emulsion, preferably from about 40% to 60% by weight latex polymer and from about 40% to 90% by weight acrylic polymer, and more preferably about 55% by weight latex polymer and about 45% by weight acrylic polymer.

In another embodiment of the invention, the present composition comprises an aqueous film-forming polymeric emulsion composed of polyurethane polymer. The present composition comprising polyurethane polymer is especially compatible with conventional printing techniques such as screen printing, and exhibits excellent stability and shelf-life at room temperature in the uncured state. Screens and other equipment could be cleaned of uncured polyurethane simply by scraping off the unwanted polyurethane polymer and wiping with an isopropanol tissue.

In a preferred embodiment of the invention, the present composition is formulated to set into a final solid or dry form upon deposition on the substrate, whereby the solid or dry form of the present composition is specifically formulated to be non-toxic and biocompatible, and is medically safe for contact with human tissue, including skin and mucosal membranes. The polymeric emulsion can be selected to harden by cross-linking of the polymers through the use of chemical additives (i.e., curing agents), ultraviolet radiation, electron beam or heat. Examples of ultraviolet curing polymers include, for example, DYMAX® 111-MSK, DYMAX® 1180-M-series, DYMAX® 1-20792 PDS, LOCTITE® 3381, and LOCTITE® 3321.

The term “imprint” as used herein is intended to refer to any impression formed from the composition of the present invention applied to or deposited on a surface of a substrate through suitable means including, but not limited to, printing processes, for producing graphic images (e.g., text and designs) including tactile or visual textures or features, and the like, on the corresponding substrate surface. The imprint may provide a decorative element, a functional element or combinations of both. The imprint may include higher strength structural elements, slow release liquid containing structures with functional inclusions, active elements such as electro-active elements, three dimensional surface texturing elements, and the like.

The term “textured imprint” as used herein is intended to refer to a particular form of imprint in which at least a portion of the imprint is raised above the surface of the substrate. Such textured imprints impart three-dimensional aspects or depth to the surface, and may include, but not be limited to, rough textures, embossed textures, bumpy textures, ribbed textures, nubby textures, prickly textures, debossed textures, woven textures, and the like.

The composition of the present invention is specifically formulated for deposition, application or printing as a printable material or ink onto substrates of elastomeric materials such as polyurethane, natural or synthetic latex, polyisoprene, and the like. The elastomeric substrate may be in the form of a film, coating, sheet, tubing, sheath, and the like.

In one embodiment of the present invention, the elastomeric substrate is a condom. The present composition can be deposited as textured imprints onto the surface of the condom, and set or cured to yield a final solid or dry form adhering firmly to the condom surface. The present composition can be formulated to set upon exposure to a setting activator selected from heat, ultraviolet light, chemical curing agents, electron beam, and the like. Upon setting of the textured imprint, the condom can readily be rolled up with the imprint into a packaged state. The resulting product is a condom with a textured surface that is non-toxic, biocompatible and medically safe for contact with human tissue, including skin and mucosal membranes.

The present composition offers a thermosetting material that does not dissolve in water or melt under heat once permanently cured, and can be used as an adhesive, or as a space-filler which is especially suitable for providing visual and/or tactile textures to a substrate surface. The present composition is also miscible with acrylic-based dyes or colorants, and remains highly elastomeric when cured. The present composition can be deposited on a substrate surface with a thickness of at least 10 microns, preferably from about 100 microns to 10 mm, and more preferably from about 200 microns to 5 mm.

In one embodiment of the invention, the present composition may further include one or more excipients including, but not limited to, inks, colorants, pigments, thickeners, fillers, stabilizers, binders, levelers, and the like. The excipients may be selected to modify or alter physical and/or chemical properties of the present composition including, for example, viscosity, adhesive strength, durability, deposition or print density, elasticity, flexibility, color, drying or curing requirements, and the like. The exipients may be present in an amount of up to 20% by weight based on the total weight of the composition.

The colorant may be selected to contribute color to the composition. The colorant may be present in an amount of up to 10% by weight based on the total weight of the composition, preferably form about 1% to 5% by weight, and more preferably from about 2% to 4% by weight. The amount of colorants will be selected based on cost considerations, and the level at which excess amounts will result in bleeding effects. Examples of suitable colorants include acrylic-based inks (e.g., SPEEDBALL), FLEXIVERSE® Violet 23, FLEXCOLORS® inks, BIRO™ inks, and the like.

The filler may be selected to impart viscosity, structure, texture, opacity, and the like. The filler may be present in an amount of up to 15% by weight based on the total weight of the composition, and more preferably from about 5% to 10% by weight. Examples of suitable fillers and thickeners include talc, CERAMOFIX™, HAKUENKA®, carbon fiber, cellulose fiber, KEVLAR® fiber, fumed silica in water (e.g., AERODISP® WR 8520), fumed silica powder (e.g., AEROSIL® 200, CAB-O-SIL®), rheology modifiers (e.g., ACRYSOL® RM8), polyurethane thickener (e.g., BORCHIGEL™ PW25), thickeners (e.g., EVONIK® TEGO® VISCOPLUS™ 3000, 3010, 3030, 3060), and the like.

The leveler may be selected to minimize the presence of bubbles in the composition and promotes a smooth appearance. The leveler may be present in an amount of up to 2% by weight based on the total weight of the composition, and preferably from 0.1% to 1.0% by weight.

The stabilizer may be selected to enhance consistency of the composition, and prevent separation of the components in the composition. The stabilizer may be present in an amount of up to 1% by weight based on the total weight of the composition, preferably from about 0.1% to 0.8% by weight, and more preferably from about 0.1% to 0.5% by weight.

The binder may be selected to enhance film forming properties of the composition. The binder may be present in an amount of up to 2% by weight based on the total weight of the composition, and preferably from about 1% to 2% by weight.

The present composition is particularly suited for producing textured imprints having three dimensional structures to impart visual or tactile textures on the surface of the substrate. Using the present composition, textured imprints embodying three dimensional designs or textures can be deposited and firmly bonded to the substrate surface. This is generally accomplished by formulating the present composition with a sufficient degree of viscosity whereby the composition can support its own weight for a sufficient time, preferably one to several minutes, to dry or cure into a final, solid state. This is generally achieved through formulation of a polymeric liquid (e.g., latex and elastomeric materials) with thickeners, fillers, viscosity modifiers and the like, thus enabling the deposited composition to substantially retain its desired form, shape and structure as it cures or dries. The present composition may be characterized by relatively high viscosity to yield a deposition thickness of at least 100 microns. The present composition may be in the form of a viscous liquid, gel, dry foam, paste, and the like. In further embodiments of the present invention, the present composition may be selected from polymeric liquids containing fillers.

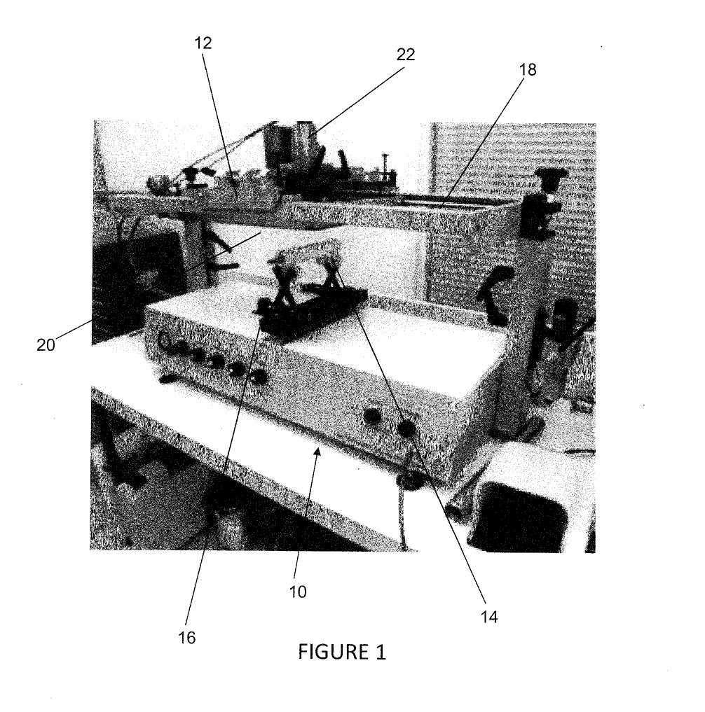

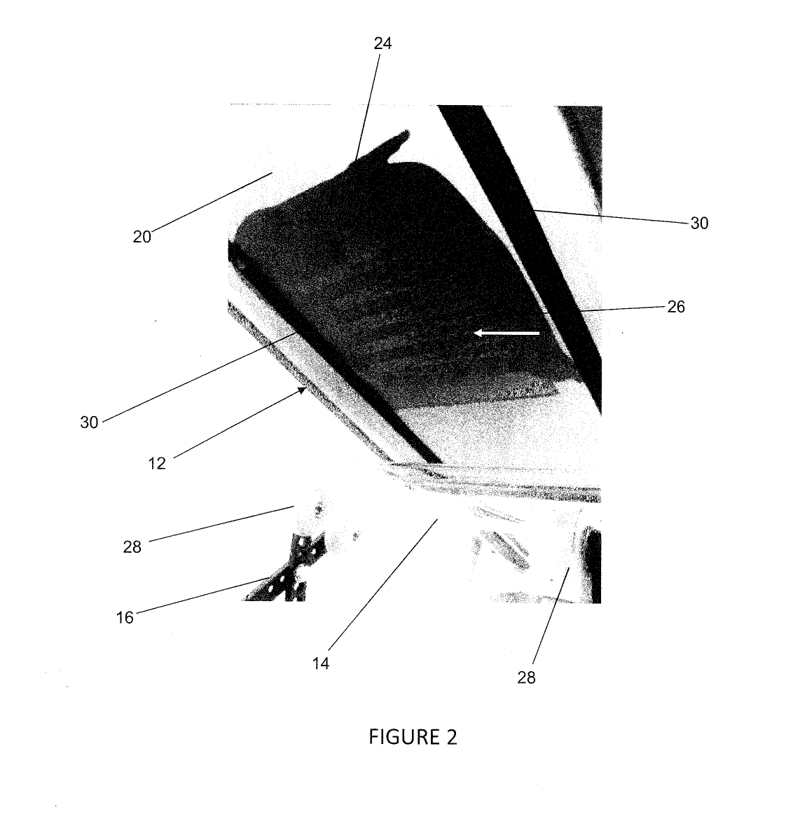

Referring to FIGS. 1 and 2, a system 10 adapted for depositing the present composition onto a tubular substrate such as a condom to form an imprint, is shown for one embodiment of the present invention. The system 10 includes a compressed-air driven screen printer 12, a mandrel 14 on which the printer 12 may apply the present composition thereon to form an imprint, and a carrier 16 for rotatively supporting the mandrel 14 thereon. The printer 12 is configured to movably slide back and forth on a set of racks 18, and includes a deposition surface 20 (as shown best in FIG. 2) and a deposition material supply assembly 22 having a squeegee or fill blade (not shown) operatively associated with the deposition surface 20 for supplying the present composition to the deposition surface 20 as will be described hereinafter. The deposition surface 20 can be composed of, for example, a mesh or screen material.

As shown in FIG. 2, the deposition surface 20 includes a stencil 24 having a plurality of outlets 26 disposed therein collectively forming a negative image of the corresponding imprint to be made on the mandrel 14. The outlets 26 represent the points at which the deposited material will appear on the surface of the mandrel 14. It is noted that a tubular elastomeric material (e.g., polyurethane, latex, polyisoprene) can be used as a substrate by slipping it over the mandrel 14 during deposition. The mandrel 14 is supported on the carrier 16 via a wheeled assembly 28. This allows the mandrel 14 to rotate freely about its longitudinal axis.

The deposition surface 20 is placed in contact with the mandrel 14 with the longitudinal axis of the mandrel 14 oriented perpendicularly to the line of travel of the printer 12. As the printer 12 slides along the racks 18, the mandrel 14, being in contact with the deposition surface 20, is drawn rotationally across the stencil 24. The mandrel 14 rotates through frictional interaction with the deposition surface 20. The deposition material supply assembly 22 pushes the present composition through the outlets 26 in the stencil 24. As the surface of the mandrel 14 contacts a corresponding portion of the stencil 24 and its outlets 26, the present composition in the outlet 26 is pumped by capillary action to the mandrel 14 in a controlled and prescribed amount. As the mandrel 14 rolls away from the contacted portion of the stencil 24, the deposited material is left upon the surface producing an imprint thereon.

In a further embodiment of the present invention, the system 10 includes a spacer member 30 in the form of a pair of strips 30 composed of a resilient material affixed to the deposition surface 20 of the printer 12. The resilient material may be composed of soft foam rubber (e.g., polyisoprene), for example. The strips 30 form tracks disposed on either side of the stencil 24 for the mandrel 14 to travel as it is drawn rotationally across the deposition surface 20. The strips 30 may be affixed to the deposition surface 20 via any suitable means including, for example, double-sided adhesive tapes.

The strips 30 act as an effective means of adjusting the snap height between the surface of the mandrel 14 and the stencil 24. The strips 30 allow the user to adjust the imprint thicknesses up to about 350 microns. The strips 30 further ensure that the rotation of the mandrel 14 is at least substantially synchronized with its travel across the deposition surface 20. In the present embodiment of the invention, the strips 30 are about 1.5 mm thick, and multiple layers of strips 30 can be used for increasing thicknesses. The thickness of the strips 30 can be selected depending on the fill blade stiffness, mesh density and viscosity of the present composition.

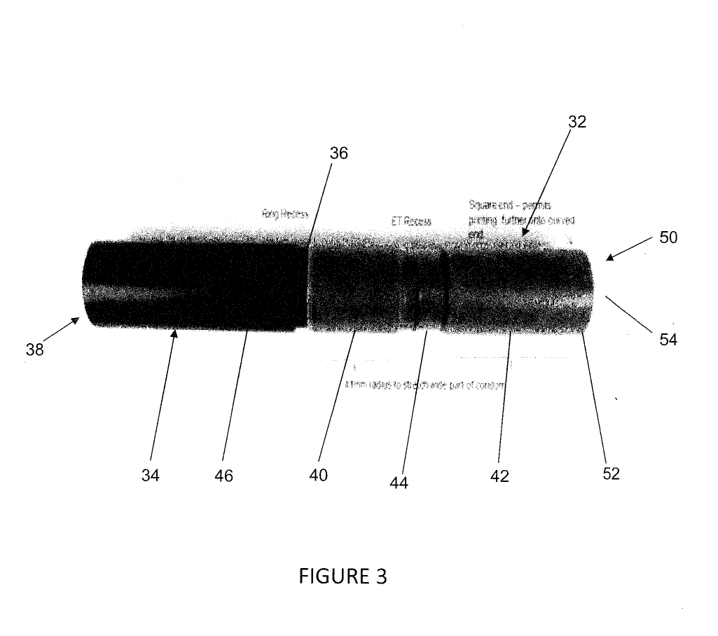

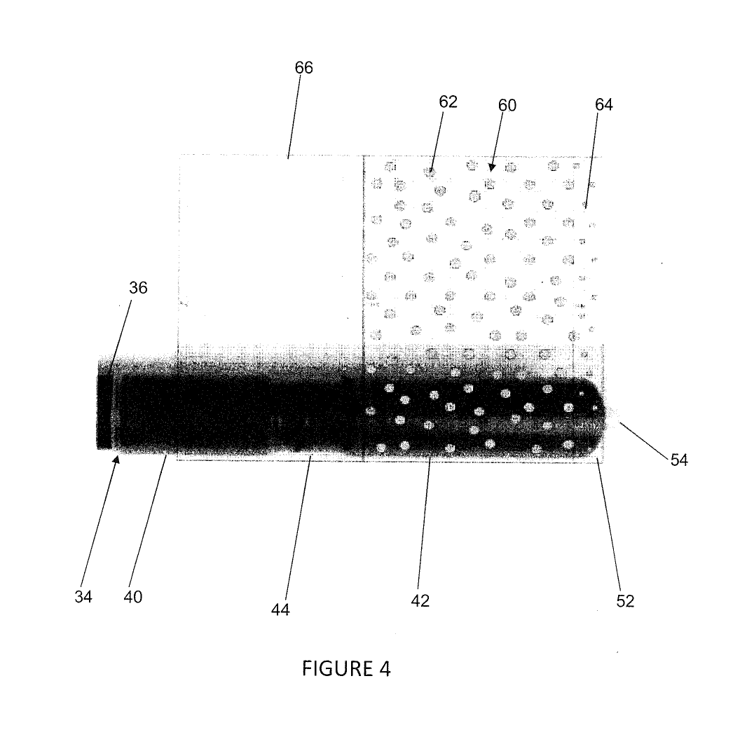

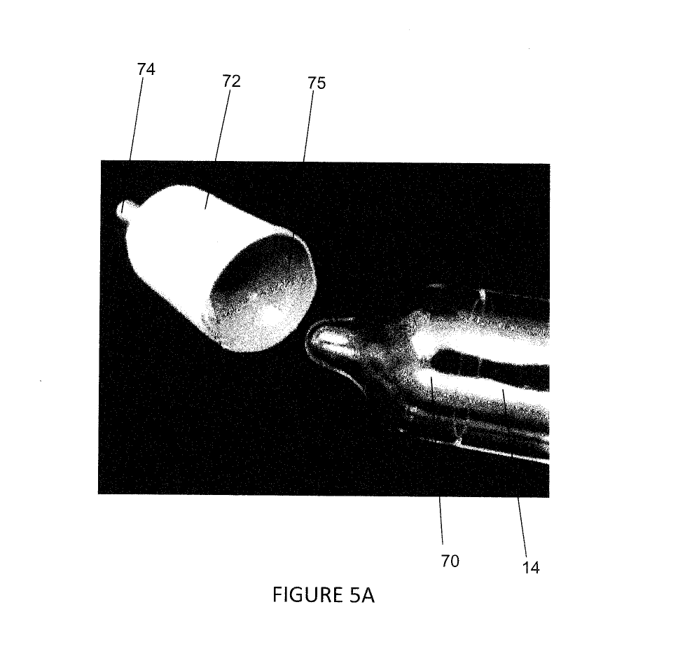

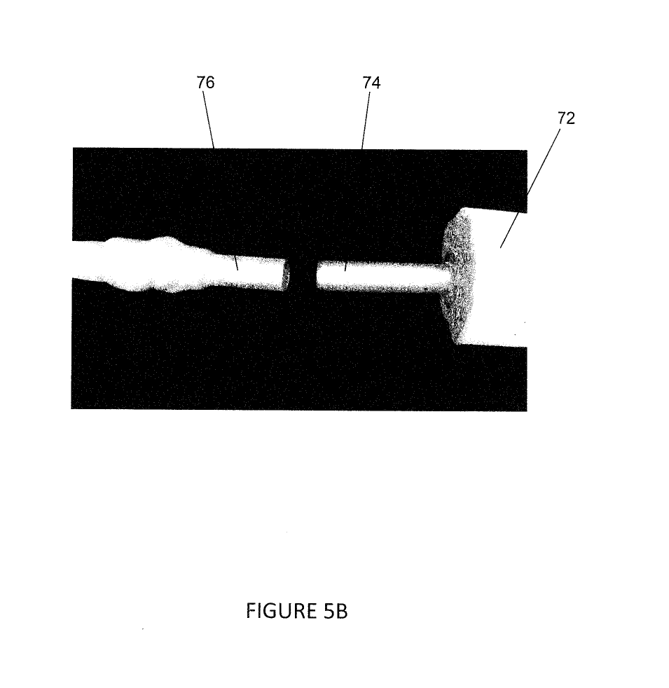

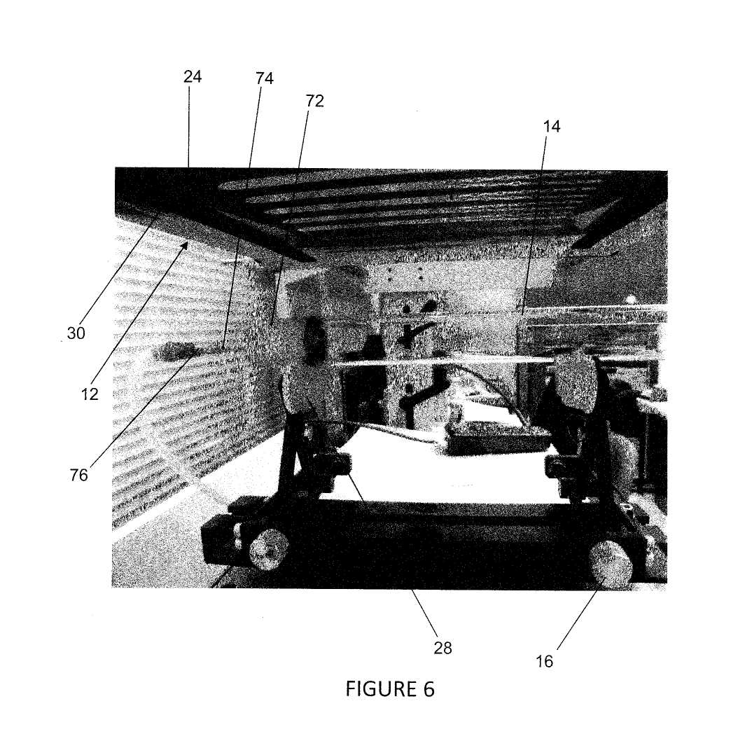

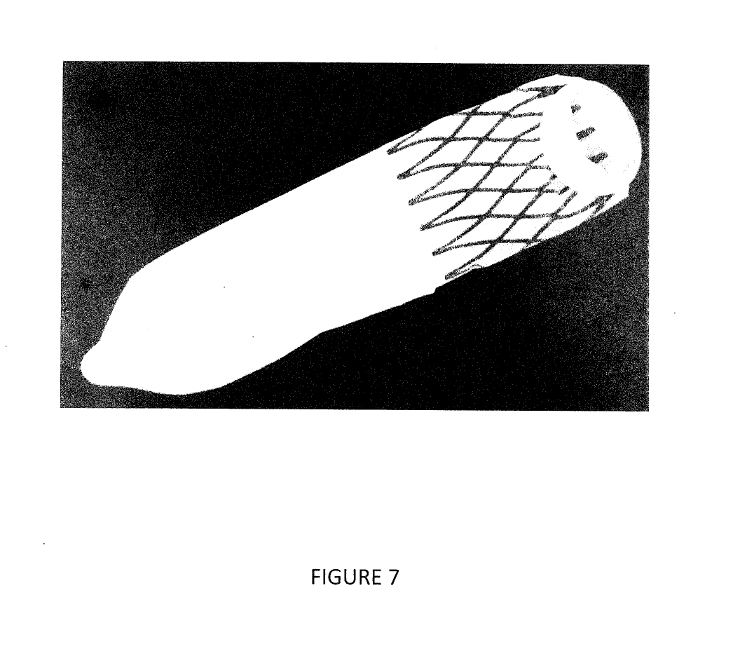

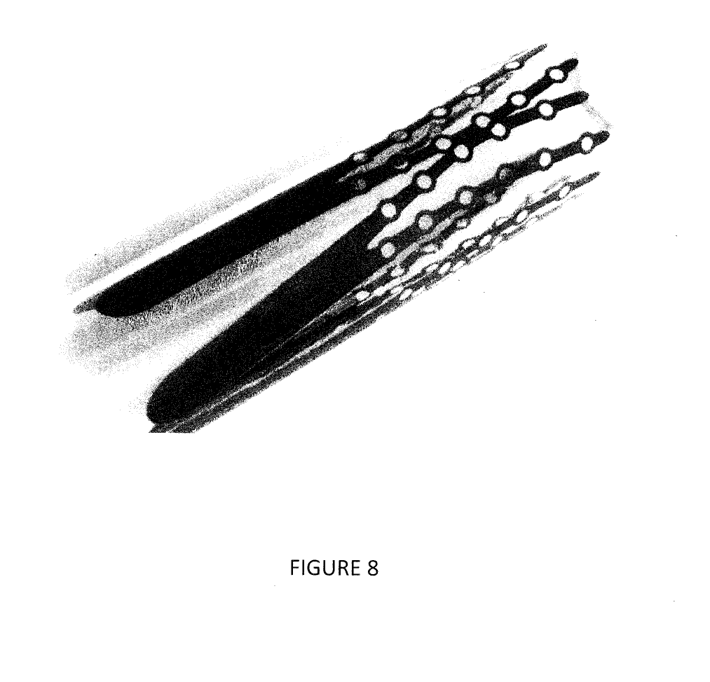

With reference to FIG. 3, there is shown an extruded plate printing apparatus 40 in accordance with another embodiment of the present invention. The apparatus 40 includes an upper plate 42 and a lower plate 44 spaced apart by a resilient spacing element 46 composed of a foam material, a reservoir 48 defined by the plates 42 and 44 and spacing element 46 for retaining the present composition therein, and a plurality of outlets or slots 48 extending through the upper plate 42. The present composition retained in the reservoir 48 passes through the plurality of outlets 48 when pressure 50 is applied downwardly on the upper plate 42. As a substrate 52 (e.g., condom) rolls over the upper plate 42 in contact with the present composition extruded through the outlets 48, a quantity of the present composition is deposited from the upper plate 42 onto the surface of substrate 52 as a textured imprint 54.

As demonstrated, the present composition can be deposited on the surface of the substrate through suitable deposition methods including, but not limited to, syringe deposition (e.g., manually, automated, valved, array, stamping), extruded plate deposition (e.g., rolled, contact), stamp printing, rotating substrate screen printing, nozzle deposition, continuous extrusion transfer, high-pressure multi-nozzle extruded deposition, three dimensional printing or additive fabrication, and the like.

In another embodiment of the invention, there is provided a method for depositing textured imprints onto a substrate, which generally comprises the step of depositing the present composition onto a surface portion of the substrate. The process of deposition may be selected from a range of suitable techniques including, but not limited to, coating, pouring, spraying, brushing, air-brushing, marbling, jet depositing, stamping, wiping, printing, or combinations thereof.

Examples of printing include needle or syringe deposition, contact printing, top feed reverse printing, bottom feed reverse printing, nozzle feed reverse printing, gravure printing, microgravure printing, reverse microgravure printing, intaglio printing, extrusion printing, deposition nozzle printing, direct printing, ink-jet printing, laser-jet printing, roller transfer (offset) printing, stencil printing, screen printing and the like. One preferred deposition technique is needle or syringe deposition. An example of a suitable needle deposition device is the 741V Series Needle Valve Depositor available commercially from Nordson Corporation of Westlake, Ohio. The needle deposition device is configured to dispense fluids in a precise manner through a needle-like assembly onto the surface of the substrate through controlled pneumatic operation.

Another preferred deposition technique is screen printing. A suitable commercially available screen printing machine is the fully automated PRESTIGE™ 5000 assembled and marketed by GravureQuip Ltd. of Surrey, United Kingdom. The screen printing technique generally involves constructing a negative of the desired pattern for the imprint on a mesh or screen, such as through the use of a stencil in which parts of the mesh are blocked, applying the present composition across the constructed mesh, and passing the composition through the open parts of the mesh onto a substrate disposed at the opposite side of the mesh.

The method of the invention may further include depositing imprints as one or more layers of the present composition onto the substrate surface. This process allows for the production of, for example, a multi-color imprint which may involve dividing the imprint into a number of different color layers. Accordingly, different formulations of the present composition comprising different grades of viscosity and/or color can be used to print both colored graphic images followed by the overprinting of structural or raised surface features or vice versa.

In a particular embodiment of the invention, the present method includes depositing the composition as textured imprints onto a mandrel, and transferring the resulting imprint onto an interior surface of a condom. The transferred imprint may be set or cured into a solid or dry form adhering firmly to the surface of the condom.

In a further embodiment of the invention, the present method may include, prior to the deposition step, pretreating the surface of the substrate to produce a clean surface substantially free of contaminants. The pretreatment of the substrate surface promotes bonding strength between the present composition and the surface to enhance adhesion and durability of the resulting imprint thereon. The pretreating step may be implemented by washing the surface of the substrate in a surface cleaning solution such as, for example, water or isopropanol. Suitable surface cleaning solutions may include SCHERCEMOL™ OHS, SCHERCEMOL™ DIA, benzyl alcohol, isopropanol, NUCHEM™, DOWANOL® PM, SURFACARE™ IPP (isopropyl palmitate), and the like.

Once the present composition is deposited on the substrate surface, the composition is allowed to set into a final solid or dry form. This can be accomplished through curing initiated by, for example, chemical additives (i.e., curing agents), ultraviolet radiation, electron beam, heat or combinations thereof.

In another embodiment of the invention, the present method may further include adding an additive in adhesive contact to the surface of the deposited composition to yield a functional coating thereon. The additive may be selected to produce physiological effects and/or sensations in humans and may be administered through contact with tissue such as, for example, the skin or mucosal membranes. The additive may be selected from fragrances, flavorants, warming agents, cooling agents (e.g., methyl salicylate), and the like.

Optionally, the additive may be infused into a carrier medium such as, for example, porous adsorbent materials, before adding to the surface of the deposited composition. The choice of carrier medium will depend on several factors including, for example, desired durability of the imprint, nature of the additive and method of deposition. In one embodiment of the present invention, a fragrance such as vanilla extract and/or a tactile or heating agent such as methyl salicylate, may be added to the porous absorbent particles such as, for example, chalk particles. The resulting infused absorbent particles may be applied and fixed on the present composition that has been deposited on the substrate prior to curing or setting of the present composition.

In one embodiment of the invention, the additive can be added to a condom having the present composition deposited onto its surface. Such functional additives produce consumer-detectable sensations (such as warming and/or lubrication) which can be localized on the condom through use of any printing technique. Most functional additives will require a carrier medium or an adhesive to be successfully printed. Choice of carrier medium will be influenced by desired durability of the print, nature of the additive, and printing method. For example, a simple solvent carrier medium will allow localized deposition of an additive. Alternatively, an adhesive carrier, such as polyurethane or latex, may be incorporated into the present composition to ensure that the additive remains in its intended position. Alternatively, an adhesive can be printed, and an additive can be laid on top of it such as by dusting with any excess removed. In a further embodiment of the present invention, an adhesive comprising polyurethane may be deposited on the substrate via printing methods and then the additive is fixedly applied to the substrate prior to setting or curing of the adhesive.

In another embodiment of the invention, there is provided an article including a substrate with a surface and the present composition deposited on the substrate surface to form textured imprints adhering thereon. The textured imprint may be in the form of decorative elements, functional elements, or combinations thereof. Preferably, the substrate is composed of an elastomeric material. The present condom may optionally include an additive adhering to the surface of the deposited composition.

In a preferred embodiment of the invention, the article is a condom. In accordance with the invention, the present composition can be specifically utilized for modifying condoms, and preformed condoms in particular. The present composition can be deposited or added onto the internal or external portions or surfaces of the corresponding condom and allowed to cure or dry. The composition can be deposited to form three dimensional structures or texture including cross ribs, spiral ribs, projections, and other textured features for the purpose of enhancing stimulatory effects in the male and female during sexual intercourse. The textured features of the condom provide increased frictional and tactile kinetics for enhanced tactile sensations and stimulation.

The present invention provides a method for depositing decorative and/or functional three-dimensional textures on preformed elastomeric articles. A further embodiment of the present invention relates to the pre-preparation of the elastomeric surface to promote the required strength of adhesion. A further embodiment of the present invention relates to using different viscosity grades of the present composition to print both colored graphic images followed by the overprinting of structural or raised surface features.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

1. A composition for depositing textured imprints onto a substrate, comprising an aqueous film-forming polymeric emulsion suspended in an aqueous medium.

2. The composition of claim 1 wherein the film-forming polymeric emulsion comprises a polymer selected from the group consisting of latex polymers, acrylic polymers, polyisoprene polymers, polyurethane polymers, polyvinyl polymers, polyepoxide polymers, polyvinyl chloride polymers, styrenic block polymers and combinations thereof.

3. The composition of claim 1 wherein the film-forming polymeric emulsion is present in the composition in an amount of up to 80% by weight based in the total weight of the composition.

4. The composition of claim 2 wherein the film-forming polymeric emulsion comprises a mixture of latex polymer and acrylic polymer.

5. The composition of claim 3 wherein the ratio of latex polymer to acrylic polymer is about 55% to 45%.

6. The composition of claim 1 further comprising at least one excipient selected from the group consisting of inks, colorants, pigments, thickeners, fillers, stabilizers, binders, levelers and combinations thereof.

7. The composition of claim 1 wherein said imprint is selected from a group consisting of a decorative element, a functional element, and combinations thereof.

8. The composition of claim 1 wherein the film-forming polymeric emulsion is formulated to set into a final solid form upon deposition on the substrate.

9. A method for depositing textured imprints onto a substrate, comprising the step of depositing said composition of claim 1 onto a surface portion of said substrate.

10. The method of claim 9 wherein the substrate is composed of an elastomeric material.

11. (canceled)

12. (canceled)

13. The method of claim 9 wherein the deposition step is implemented by printing said composition onto said substrate surface.

14. The method of claim 13 wherein the printing step is implemented through screen printing.

15. The method of claim 9 further comprising setting the deposited composition into a final solid form.

16. The method of claim 15 wherein the setting step is implemented through exposure of the solid form to a treatment selected from the group consisting of heat, ultraviolet light, and combinations thereof.

17. The method of claim 15, prior to the setting step, adding an additive in adhesive contact onto the surface of the deposited composition.

18. The method of claim 9 further comprising depositing a plurality of layers of the composition onto the substrate surface.

19. The method of claim 9 wherein the substrate <is a condom.

20. The method of claim 9 comprising contacting the substrate with a textured printing surface.

21. The method of claim 20 wherein the texture printing, surface comprises:
first and second plates spaced apart from one another via a spacing element disposed therebetween;
a reservoir defined between the first and second plates and the spacing element for retaining the composition therebetween; and
a plurality of outlets extending through the first plate in communication with the reservoir.

22. An article comprising:
a substrate having a surface; and
the composition of claim 1 deposited on the substrate surface to form textured imprints adhering thereon.
